(19) United States
(12) Patent Application Publication
(10) Pub. No.: US 2026/0030354 A1
(43) Pub. Date: Jan. 29, 2026

(54) HIGHLY EFFICIENT WEBPAGE CODE-PATTERNS MATCHING FOR MALICIOUS WEBSITES DETECTION

(71) Applicant: Palo Alto Networks, Inc., Santa Clara, CA (US)

(72) Inventors: Xunhua Tong, San Jose, CA (US); Jingwei Fan, Chapel Hill, NC (US); Jiaqi Wu, Santa Clara, CA (US)

(21) Appl. No.: 18/785,068

(22) Filed: Jul. 26, 2024

(51) Int. Cl. G06F 21/56

(52) U.S. Cl. CPC G06F 21/56

(57) ABSTRACT

Building a highly efficient lookup infrastructure for malicious webpage detection is approached as a set covering problem. A malicious code patterns list is analyzed to determine which alignment relative positional indexing covers the most patterns with the least indexes. After determining which alignment relative positional indexes cover most, if not all, of the code patterns, the indexes are built. The alignment relative positional indexing schemes are stored to be applied to code patterns extracted from webpages when performing a lookup on the list of malicious code patterns for malicious webpage detection.

### BACKGROUND

The disclosure generally relates to data processing (e.g., CPC subclass G06F) and to a security arrangement for protecting computers (e.g., CPC subclass G06F 21/00).

Malicious program code or malware can be delivered via webpages. In addition to malicious webpages created by cybercriminals, legitimate webpages can be compromised. Malware can be injected directly into a webpage or delivered via third party integrations (e.g., drive-by download attack).

One of the techniques for detecting malware is signature detection. Cybersecurity experts will analyze malware and determine a pattern that is a digital fingerprint of malware. The pattern can be a pattern of program code, such as markup language program code, or a pattern of bits. The pattern or a hash of the pattern is then used as a signature. A cybersecurity tool, appliance, or application will maintain a list of these malware signatures. When scanning a file or network traffic, patterns are extracted from the file or network traffic and the signatures list is searched. A match indicates detection of the malware corresponding to the matching signature.

### BRIEF DESCRIPTION OF THE DRAWINGS

Embodiments of the disclosure may be better understood by referencing the accompanying drawings.

FIG. 1 is a conceptual diagram of a malicious webpage detector and its lookup infrastructure for highly efficient detection of malicious content in a webpage.

FIG. 2 is a diagram of example contents of the tables 111, 113 of FIG. 1 to aid in describing the technology.

FIG. 3 is a flowchart of example operations for building an alignment relative positional lookup infrastructure for malicious code patterns.

FIG. 4 is a flowchart of example operations for generating index(es) based on best set covering of code across patterns by alignment relative positional indexing.

FIG. 5 is a flowchart of example operations for detecting whether webpage contains malicious content based on code patterns.

FIG. 6 depicts an example computer system with a code pattern-based malicious webpage detector.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

The description uses the term “extract” in its plain meaning of to draw forth. In the context of generating a code pattern, codes are drawn forth from a webpage to form the pattern. Drawing forth the code can be determining a regular expression in a section and associating the regular expression with a section identifier or generating a hash of the content of a section and associating the hash value with a section identifier.

The term “in-line” is a contrast with “offline” or “out-of-band.” In networking, in-line used as a modifier for processing of network traffic refers to processing network traffic in the communication path that the network traffic is traversing (e.g., on the router or gateway). If traffic is being processed out-of-band, the traffic are being sent or copies of the traffic are being sent to a remote location for processing (i.e., outside of the network device).

The description uses the term “infrastructure” in the context of the high efficiency searching disclosed herein to refer to the structures that facilitate the lookups or searching. Due to the adaptive aspect of the technology, the infrastructure may be one hash table or multiple hash tables. The particular data structure(s) used for the infrastructure can also vary. For instance, different indexes of different alignment relative positional indexing may reference corresponding entries in a list of malicious code patterns.

### Overview

Time is a critical aspect of network security. In-line scanning of network traffic for an attack or malware must satisfy the competing goals of thoroughness and minimizing or avoiding introduction of latency from scanning and analysis. The challenge of satisfying these competing goals increases in difficulty with malware signatures growing and already at a magnitude of hundreds of thousands.

It has been discovered that adaptive position-based indexing achieves highly efficient lookup for malicious webpage detection. When a list of malicious code patterns/signatures are loaded (e.g., into a firewall), the list is analyzed to determine which alignment relative positional indexing covers the most patterns with the least indexes, which treats the determination of indexing as a set covering problem. After determining which alignment relative positional indexes cover most, if not all, of the code patterns, then the indexes are built. The alignment relative positional indexing schemes are stored to be applied to code patterns extracted from webpages when performing a lookup on the list of malicious code patterns for malicious webpage detection. For instance, the leftmost code in the extracted code pattern would be first used for a lookup and then a middle code, if that is how the indexes referencing the list of malicious code patterns were built. If an index hits, then the extracted code pattern is compared against the malicious code pattern corresponding to the hit index. Lookups continue until successful or until all indexes have been used. Experiments suggest that despite the variety in markup language based code patterns, three indexes cover more than 99% of possible matches in a list of multiple hundreds of thousands of code patterns. In addition, searching a list of 300,000 malicious code patterns with the disclosed technique achieved a rate of approximately 0.03 milliseconds per webpage. Moreover, the search time is approximately constant across increasing sizes of the malicious code patterns list.

### Example Illustrations

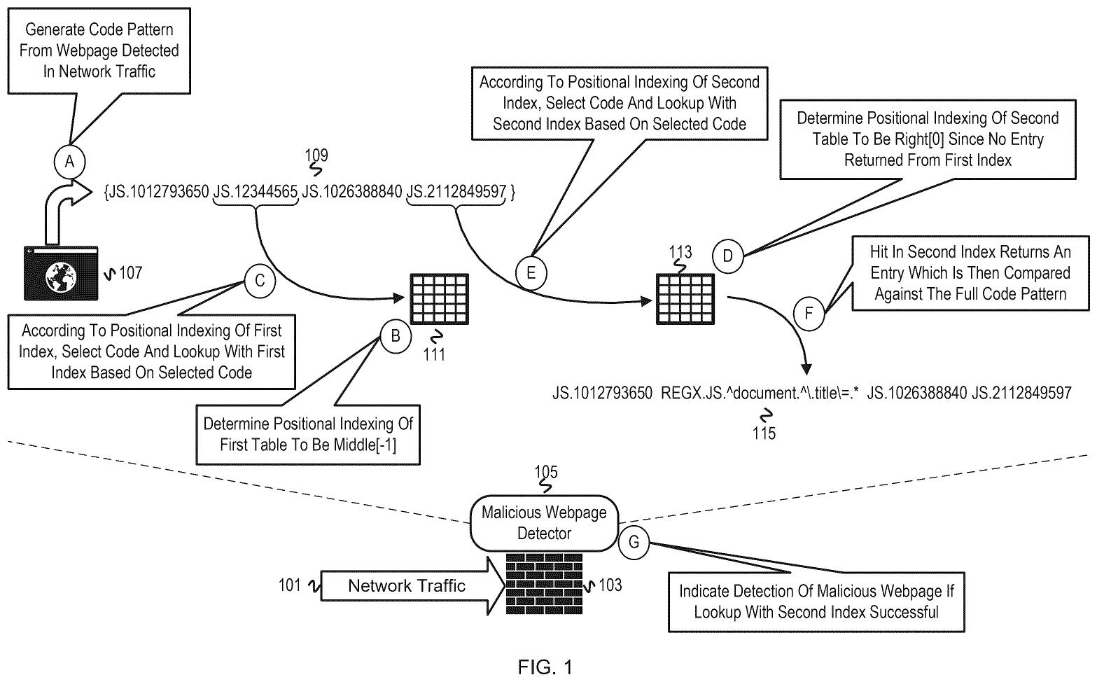

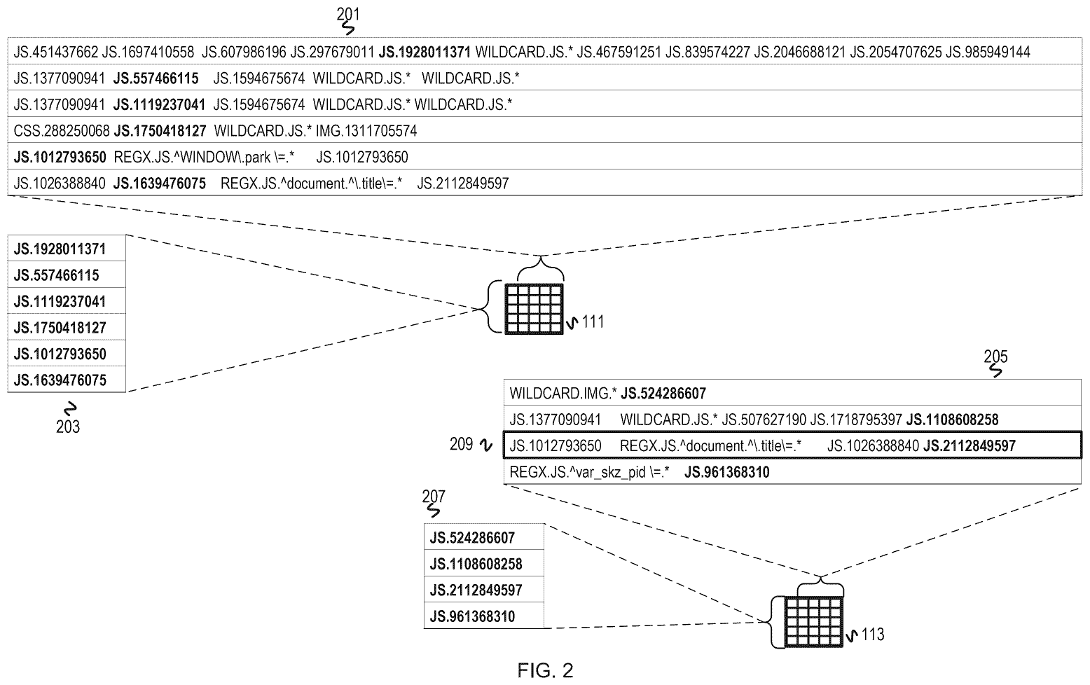

FIG. 1 is a conceptual diagram of a malicious webpage detector and its lookup infrastructure for highly efficient detection of malicious content in a webpage. FIG. 1 depicts a malicious webpage detector 105 as installed on a firewall 103 that is processing network traffic 101. The malicious webpage detector 105 uses hash tables 111, 113 for efficient lookup of an extracted code pattern to determine whether it matches a malicious code pattern in one of the hash tables 111, 113. FIG. 2 is a diagram of example contents of the tables 111, 113 of FIG. 1 to aid in describing the technology. Each table 111, 113 uses different positional indexing relative to an alignment, which can be left, right, or middle. Positional indexing relative to a left alignment means that the positions [0, 1, 2 . . . ] are relative to a leftmost code. Positional indexing relative to a right alignment means that the positions [0, 1, 2 . . . ] are relative to a rightmost code. Positional indexing relative to a middle alignment means that the positions [ . . . 2, −1, 0, 1, 2 . . . ] are relative to a middle code, which will vary depending upon length of the code. For positional indexing relative to a middle alignment, this description will rely on a paradigm that chooses the code at the quotient of x and 2, with x being the number of codes in the pattern or length of the pattern. Furthermore, the description will refer to the values used as indices and selected codes for lookup instead of repeatedly referring to hashes of the values or hashes of the selected codes for brevity.

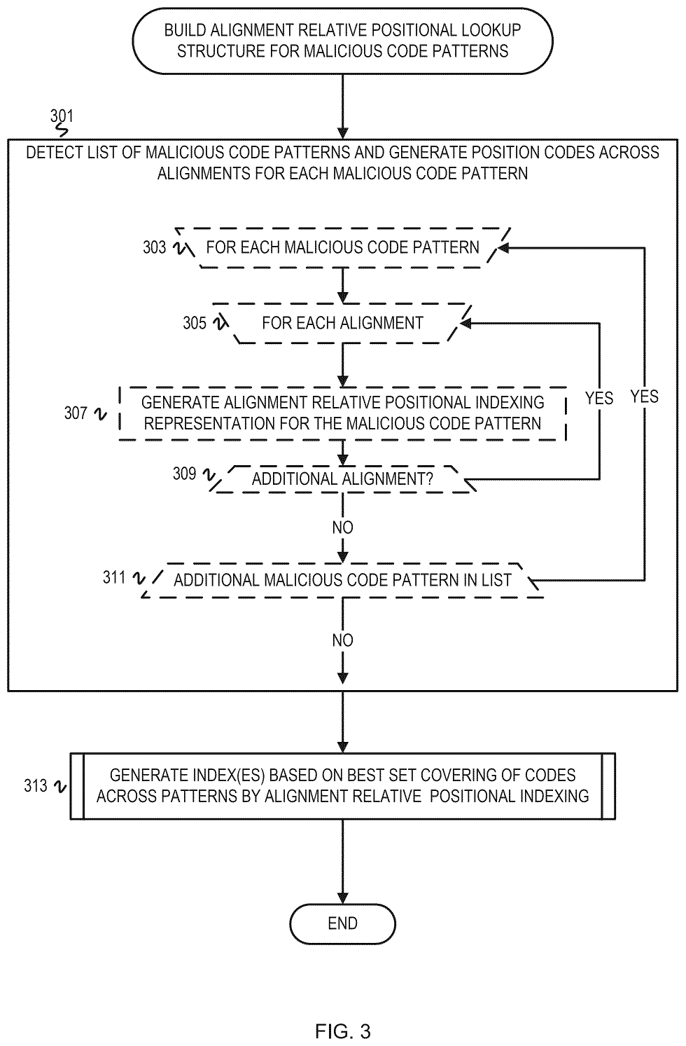

The malicious web page detector 105 builds the hash tables 111, 113 in advance of scanning network traffic. The malicious web page detector 105 builds hash tables or indexes when a set of malicious patterns/signature is loaded. More detail regarding the building of indexes/hash tables is provided with reference to FIG. 3.

While scanning the network traffic 101, the firewall 103 detects a webpage 107. FIG. 1 is annotated with a series of letters A-G depicting stages of analysis of the webpage 107 by the malicious webpage detector 105 to determine whether it contains malicious content. Each stage represents one or more operations. Although these stages are ordered for this example, the stages illustrate one example to aid in understanding this disclosure and should not be used to limit the claims. Subject matter falling within the scope of the claims can vary from what is illustrated.

At stage A, the malicious webpage detector 105 generates a code pattern 109 from the webpage 107 detected in the network traffic 101. The malicious webpage detector 105 examines sections of the webpage 107 as delineated by tags. Based on heuristics, the malicious webpage detector 105 identifies which sections should have a code generated and generates a code accordingly. For instance, heuristics indicate that code should be generated from script sections and title sections. The malicious webpage detector 105 parses a webpage and for each script section computes a hash of the content within the tags <script> and </script>. Similarly, the malicious webpage detector 105 parses a webpage to find a title section and computes a hash of the content within the tags <title> and </title>. Implementations can vary, but in this example the generated codes are some form of the tag with the hash value concatenated (e.g., {TAG}. {hash_value}). In this example, the malicious webpage detector 105 generates the code pattern 109 based on four JavaScript® sections in the webpage 107. To generate a code, the malicious webpage detector 105 hashes the content within the corresponding tag, such as JavaScript tags. Using the first code in the code pattern 109 to illustrate, the first code is the code identifier “JS” followed by the hash value “1012793650” generated from the script or content within the JavaScript tags. The code identifier and the hash value of the contents are separated by a period.

At stage B, the malicious webpage detector 105 determines the alignment relative positional indexing of the first table 111. The alignment relative positional indexing can be encoded into metadata of the table 111. The malicious webpage detector 105 determines that the alignment relative positional indexing is “Middle [−1].” This indicates that the hash table keys or indices are codes at position −1 relative to a middle code within the malicious code patterns of the table 111.

At stage C, the malicious webpage detector 105 selects a code of the code pattern 109 and performs a lookup in the table 111 with the selected code. The malicious webpage detector 105 selects the code of the code pattern according to the positional indexing of the first table 111 which was determined to be Middle [−1]. If a first position of a code pattern is indexed as 0, the middle code of the code pattern 109 is indexed by 2, which is position 0 relative to alignment Middle. Thus, in the code pattern 109, the middle code is JS.1026388840 and the code JS.12344565 is the code at Middle [−1] (i.e., one left of the middle assuming a left to right direction). This selected code is used to perform a lookup in the table 111.

In FIG. 2, six pattern entries 201 of the table 111 are depicted. The six pattern entries 201 include six malicious code patterns. The code patterns include codes from JavaScript sections, cascading style sheet (CSS) sections, and image sections. Some of the codes include a “WILDCARD” and “*” for dynamic matches. Some code also include “REGX” to indicate that a regular expression should be matched in a designated section to determine whether the malicious code pattern is detected. While part of the patterns, the wildcard and regular expression codes are not used to index the malicious code patterns, but still occupy a position in the code. A pattern with a regular expression or wildcard code cannot be indexed by that code because it will yield too many false hits. Indices 203 are the codes at Middle [−1] of the code patterns 201. Based on these example values, there is no hit or match in table 111 for the code pattern 109.

At stage D, the malicious webpage detector 105 determines the alignment relative positional indexing of the second table 113. The malicious webpage detector 105 determines that the alignment relative positional indexing is “Right [0].” This indicates that the hash table keys or indices are codes at position 0 relative to a rightmost code within the malicious code patterns of the table 111, which means the rightmost codes. The alignment relative positional indexing can be encoded into metadata of the table 113.

At stage E, the malicious webpage detector 105 selects a code of the code pattern 109 and performs a lookup in the table 113 with the selected code. The malicious webpage detector 105 selects the code of the code pattern according to the positional indexing of the second table 113 which was determined to be Right [0]. In the code pattern 109, the Right [0] or rightmost code is JS.2112849597. This selected code is used to perform a lookup in the table 113.

At stage F, the malicious webpage detector 105 compares an entry returned from the lookup in the table 113 with the selected code “JS.2112849597” of the extracted code pattern 109. Referring again to FIG. 2, the table 113 is depicted with entries 205 of example malicious code patterns. As the alignment relative positional indexing is Right [0], the rightmost code that is not a dynamic code (e.g., includes a wildcard or regular expression) is used as the index. Indices 207 of the table 113 for the entries 205 are depicted. The lookup with the code JS.2112849597 from the code pattern hits a third entry 209 of entries 205, which returns a malicious code pattern 115 which is “JS.1012793650 REGX·JS·\hat{ }document·\hat{ }\·title=·*JS.1026388840 JS.2112849597” for comparison with the extracted code pattern 109. The first, third, and fourth codes between the extracted code pattern 109 and the returned malicious code pattern 115 will match. However, the second code of the returned malicious code pattern 115 includes a regular expression code. The malicious webpage detector 105 will search the content of the JavaScript section corresponding to the second code of the code pattern 109 for the specified regular expression “\hat{ }document·\hat{ }\·title=*” within that section. If the regular expression is matched, then the malicious webpage detector 105 determines that the code pattern 109 matches the malicious code pattern 115.

At stage G, the malicious webpage detector 105 indicates detection of a malicious webpage or detection of malicious content in the webpage 107. For this illustration, it is presumed that the regular expression matched in the JavaScript section of the code pattern 109. The detection of the malicious webpage or malicious webpage content triggers a security action on the corresponding session in the network traffic 101 (e.g., generating a notification, blocking traffic, etc.).

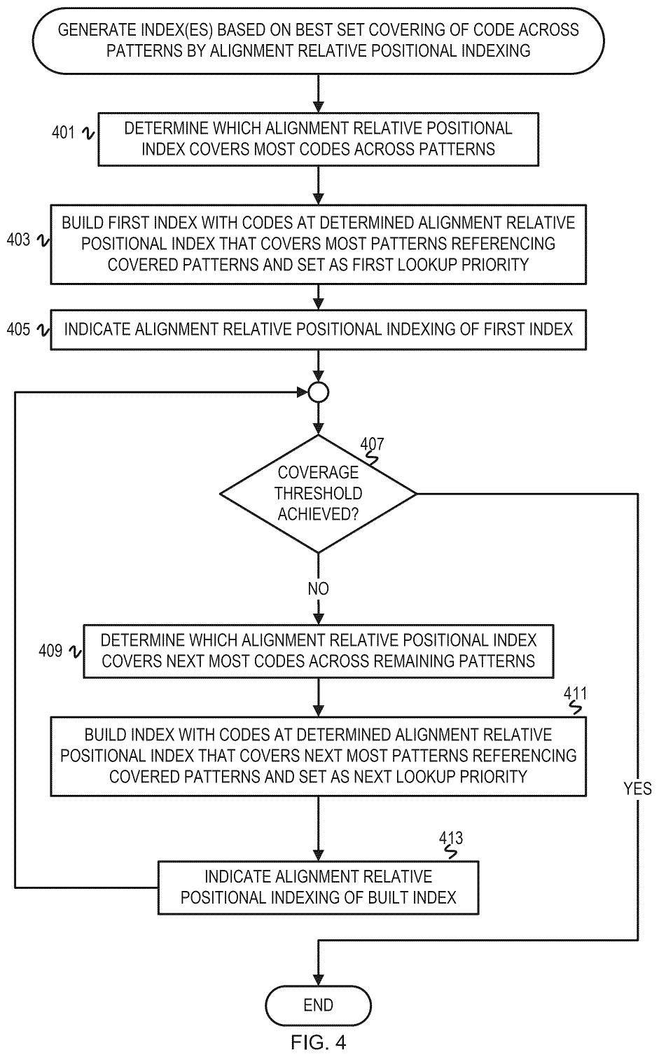

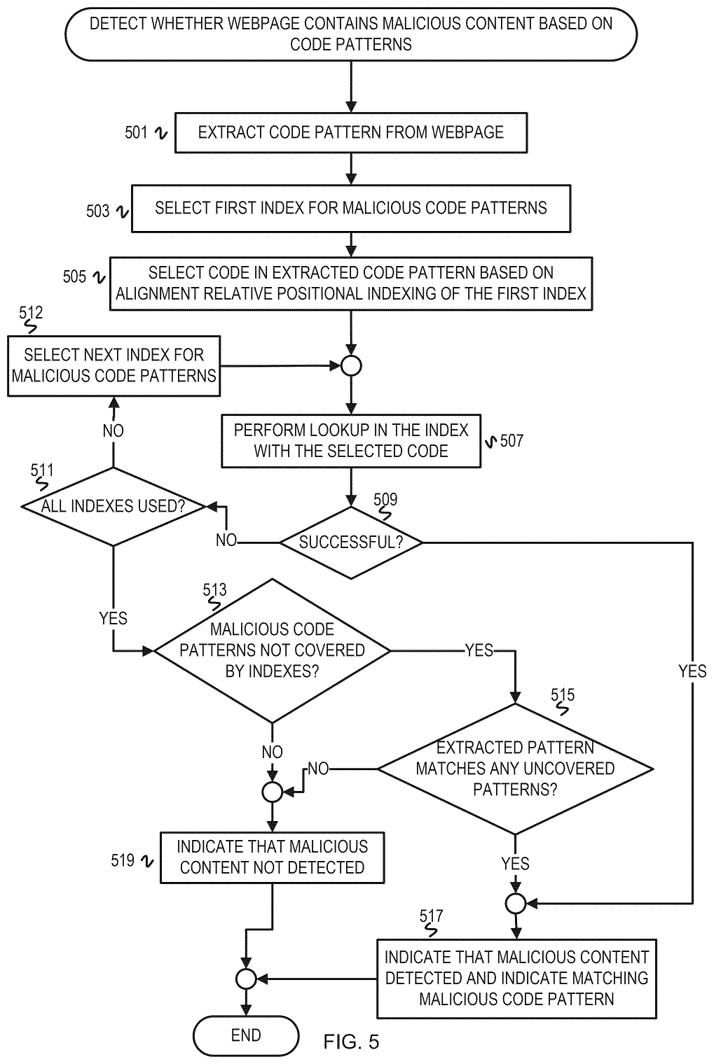

Detection relies on building the lookup infrastructure based on the malicious code patterns in a list loaded into a firewall or security application that inspects traffic. FIGS. 3-4 are flowcharts that correspond to building the infrastructure, which includes one or more indexes and the metadata indicating the alignment relative positional indexing for each index. For detection based on the build infrastructure, FIG. 5 more generally describes the detection with the efficient lookup infrastructure as compared to the specific example illustrated in FIG. 1. The example operations are described with reference to a malicious webpage detector for consistency with FIGS. 1 and 2 and ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for building an alignment relative positional lookup infrastructure for malicious code patterns. A list of malicious code patterns is analyzed to determine the least indexes that cover most or all the malicious code patterns, with each index corresponding to a different alignment relative position. The infrastructure is created based on the analysis.

At block 301, the malicious webpage detector detects a list of malicious code patterns and processes the list to generate position code based representations across alignments for each malicious code patterns Periodically or on-demand, a new list of malicious code patterns will be loaded onto a security appliance or firewall. When this is detected, the list is processed to create the most efficient indexes for searching for matches among the malicious code patterns listed. A first phase in the analysis is determining the positions occupied by the codes in each malicious code pattern with respect to the different alignments. Using the three aforementioned alignments, the malicious webpage detector will determine right relative position codes, left relative position codes, and middle relative position codes for each malicious pattern. In a second phase, the different alignment relative positional representations are analyzed to determine the best set covering—the sets being the malicious code patterns diverging by which alignment relative positional representations they have. Block 301 includes blocks 303, 305, 307, 309, 311 depicted in dashed lines. The dashed lines indicate that the operation(s) represented by block 301 can be implemented differently and that the internal blocks depict one example implementation. For instance, how the list of malicious patterns is traversed can vary in multiple implementations.

At block 303, the malicious webpage detector begins iterating over each of the malicious code patterns in the list to generate various representations. Generating the representations provides the different alignment relative positional indexing available for each of the malicious code patterns. Since code patterns can be of varying sizes, using evaluating positive relative to different alignments instead of a single alignment allows the set covering analysis to be independent of code pattern size.

At block 305, the malicious webpage detector iterates over the different alignments. The malicious webpage detector iterates through the alignments to generate representations across alignments for each malicious code pattern.

At block 307, the malicious webpage detector generates alignment relative positional indexing representations for the malicious code pattern. The malicious webpage detector iterates over the codes of the code pattern, indexes each code relative to the current alignment, and determines whether the code can be used as an index. A code that includes a dynamic component, such as a regular expression or wildcard, is not used as an index and means that the corresponding position does not cover that code pattern. To illustrate, consider the malicious code pattern “JS.1026388840 JS.1639476075 REGX·JS·\hat{ }document·\hat{ }\·title=·*JS.211284959”. Below are example representations generated across alignment iterations assuming 0 refers to an initial position and moving to the left is indicated with a negative sign.

| | |
|---|---|
| Right | R[0]: JS.211284959, R[−1]: REGX.JS.\hat{ }document.\hat{ }\.title=.*, |
| | R[−2]: JS.1639476075, R[−3] JS.1026388840 |
| Left | L[0]: JS.1026388840, L[1]: JS.1639476075 L[2]: |
| | REGX.JS.\hat{ }document.\hat{ }\.title=.* L[3]: JS.211284959 |
| Middle | M[−2]: JS. 1026388840, M[−1]: JS.1639476075, M[0]: |
| | REGX.JS.\hat{ }document.\hat{ }\.title=.*, M[1]: JS.211284959 |

Based on the above, the malicious webpage detector would determine that this malicious code pattern cannot be indexed by R[−1], L[2], or M[0].

At block 309, the malicious webpage detector determines whether there is another alignment for generating a representation of the malicious code pattern. If there is an additional alignment, operational flow returns to block 305. If not, then operational flow proceeds to block 311.

At block 311, the malicious webpage detector determines whether there is an additional malicious code pattern to process in the list. If there is an additional malicious code pattern, then operational flow returns to block 303. Otherwise, operational flow proceeds to block 313.

At block 313, the malicious webpage detector generates index(es) based on best set covering of codes across patterns by alignment relative positional indexing. FIG. 4 presents example operations based on a greedy algorithm, but embodiments can use other algorithms. As examples, embodiments can use a combination algorithm, a linear programming (LP) relaxation and rounding algorithm, and a branch and bound algorithm

FIG. 4 is a flowchart of example operations for generating index(es) based on best set covering of code across patterns by alignment relative positional indexing. After generating the different alignment relative positional indexing representations for each malicious code pattern, the malicious webpage detector can use the representations to solve the set covering problem of minimal indexes to index most or all of the malicious code patterns.

At block 401, the malicious webpage detector determines which alignment relative positional index covers most codes across patterns. For instance, the malicious webpage detector examines the representations of each malicious code pattern to determine which alignment relative positional index, such as R[0], occurs more frequently or is most common across the malicious code patterns when disregarding dynamic codes. This most commonly occurring alignment relative positional index covers the most patterns.

At block 403, the malicious webpage detector builds a first index with codes at the alignment relative positional index determined to cover most patterns. The indices reference their corresponding covered patterns. The first index is set with the highest or first lookup priority. This can be explicitly set, such as in metadata for the lookup infrastructure. Or, this can be implied by defining the lookup function to access the index first. Continuing with R[0] as the alignment relative positional index with greatest coverage, the malicious webpage detector builds an index of keys by hashing the static codes at R[0] across the list of malicious code patterns. The covered patterns are removed from consideration.

At block 405, the malicious webpage detector indicates alignment relative positional indexing of the first index. As stated previously, the indication of which alignment and position is the basis for the index can be stored as an attribute or metadata for the index.

At block 407, the malicious webpage detector determines whether a coverage threshold has been achieved. The coverage threshold can be 100% or near complete coverage, such as 99%. Malicious code patterns not covered by the indexes would be set in a separate table or listing for full pattern matching if lookups in the preceding indexes are not successful. If the coverage threshold is achieved, then operational flow ends in FIG. 4. Otherwise, operational flow proceeds to block 409.

At block 409, the malicious webpage detector determines which alignment relative positional index covers next most codes across remaining patterns. After removal from consideration those of the patterns covered by the preceding index(es), the malicious webpage detector again analyzes the different representations to determine which alignment relative positional index covers the most of the remaining malicious code patterns.

At block 411, the malicious webpage detector builds an index with codes at the alignment relative positional index determined to cover the next most patterns of the remaining malicious code patterns. The indices reference their corresponding covered patterns. The index is set with the next highest lookup priority relative to the preceding index(es). For this index, it is assumed that M[1] has the next greatest coverage. The malicious webpage detector builds an index of keys by hashing the static codes at M[1] across the remaining malicious code patterns. The covered patterns are removed from consideration.

At block 413, the malicious webpage detector indicates the alignment relative positional indexing of the built index. Again, this can be in metadata or in how the lookup function is defined. Operational flow returns to block 407 from block 413. With this implementation, the number of indexes or hash tables that form the lookup structure or lookup infrastructure is not known until the coverage threshold is achieved. The size and the type of codes that constitute the code patterns will impact the solution to the indexing characterized as a set covering problem.

FIG. 5 is a flowchart of example operations for detecting whether a webpage contains malicious content based on code patterns. The example operations allow for an additional table of malicious code patterns that are not covered by the indexes. If the lookups by index fail, then the remaining code patterns are compared in full. For this description, a successful lookup encompasses a hit on the index and a match to the returned entry. Likewise, a failed lookup means either the selected code from the extracted code pattern did not match an index or the index matched but the corresponding entry did not match the extracted code pattern.

At block 501, the malicious webpage detector extracts a code pattern from a webpage. While the previous examples presume in-line detection of a webpage, embodiments are not limited to in-line scanning. The disclosed high efficiency matching technique can be used for offline analysis of a webpage or websites. Regardless of whether the analysis is offline or in-line, the malicious webpage detector inspects sections of the code of the webpage and extracts codes to form a code pattern.

At block 503, the malicious webpage detector selects the first index for malicious code patterns. Whether indicated in metadata of the lookup infrastructure or encoded into the lookup function, the first index or hash table is selected.

At block 505, the malicious webpage detector selects a code in the extracted code pattern based on alignment relative positional indexing of the first index. The malicious webpage detector determines an alignment of the first index and positional indexing relative to that alignment and selects a code in the extracted code pattern accordingly.

At block 507, the malicious webpage detector performs a lookup in the selected index with the selected code. Execution of a lookup function will search the index for the selected code and either return a fail indicator or the entry referenced by the matching index.

At block 509, the malicious webpage detector determines whether the lookup was successful. If the lookup was successful, then operational flow proceeds to block 517. If not, then operational flow proceeds to block 511.

At block 511, the malicious webpage detector determines whether all indexes have been used or all of the hash tables have been traversed. If not, then operational flow proceeds to block 513. If all indexes have not been used, then operational flow proceeds to block 512 for the next index to be searched.

At block 512, the malicious webpage detector selects the next index for malicious code patterns. The malicious webpage detector will continue traversing the indexes until exhausted. Operational flow returns from block 512 to block 507 for a lookup in the newly selected index.

If all indexes have been used, then at block 513 the malicious webpage detector determines whether the list of malicious code patterns included code patterns that were not covered by the indexes. In terms of hash tables, the malicious webpage detector determines whether there are any malicious code patterns not in the hash tables. If there are no remaining uncovered malicious code patterns (e.g., malicious code patterns not in the hash tables), then operational flow proceeds to block 519. If there are remaining uncovered malicious code patterns, then operational flow proceeds to block 515.

If all indexes have been traversed and there are uncovered malicious code patterns, then at block 515, the malicious webpage detector determines whether the extracted pattern matches any of the uncovered malicious code patterns. The malicious webpage detector compares the extracted pattern to each of the uncovered malicious code patterns until either a match is found or the uncovered patterns are traversed. If no match is found, then operational flow proceeds to block 519. If a match is found, then operational flow proceeds to block 517.

At block 517, the malicious webpage detector indicates that malicious content is detected and indicates the matching malicious code pattern. Indication that malicious content was detected in the webpage can be used by another process for a security action, such as blocking the domain or warning a user. Indication of the malicious code pattern that was matched allows for additional analysis or information. For example, threat or severity can be determined from the matched malicious code pattern. As another example, the matched malicious code pattern may be an indication of a malicious campaign.

If all indexes have been used and either there are no uncovered patterns or no match with any of the uncovered patterns, then at block 519, the malicious webpage detector indicates that malicious content is not detected for the webpage. Based on this indication, the traffic carrying the webpage could continue.

### Variations

The examples allow for a solution to the set covering problem that has less than 100% coverage—i.e., a small number of malicious signatures/patterns in the list are not covered by the built indexes. Embodiments can instead modify uncovered malicious code patterns to be covered by the built indexes. For instance, the example operations of FIG. 4 would include additional operations for determining whether there are uncovered malicious patterns in the list and for modifying the uncovered malicious patterns to be covered by the build indexes. For instance, a placeholder or blank space can be inserted to occupy a position in an uncovered malicious pattern. Referring to FIG. 5, the operations that address uncovered patterns would not be performed since all patterns in a list would be indexed.

In addition, the description provides a few examples of sections that would be processed to extract codes. In addition to those already used for illustration, examples can also include an iframe section of a webpage, an image section of a webpage, and elements in a header of a HTTP request or response. The disclosed system can parse the HTTP request/response header communicated as part of HTTP. Furthermore, the functionality can be applied to sections to be developed since they will have the commonality of being delimited by tags.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, additional operations could be depicted in FIG. 4 to build an additional list for uncovered patterns. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

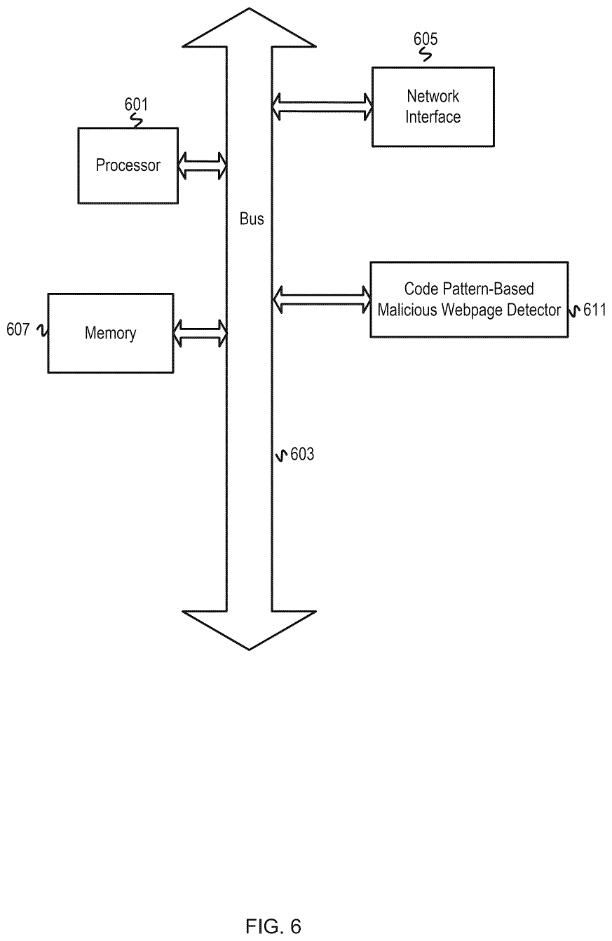

FIG. 6 depicts an example computer system with a code pattern-based malicious webpage detector. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605. The system also includes code pattern-based malicious webpage detector 611. The code pattern-based malicious webpage detector 611 creates a lookup/searching infrastructure for each listing of malicious code patterns loaded onto the computer system. The code pattern-based malicious webpage detector 611 builds the infrastructure to adapt to the contents of the loaded pattern list. The code pattern-based malicious webpage detector 611 determines different positional indexing relative to different alignments for each malicious code pattern. The code pattern-based malicious webpage detector 611 then determines the combinations of alignment relevant positional indexing covers the most or all of the malicious code patterns and builds the infrastructure accordingly. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

1. A method comprising:
determining whether a webpage includes malicious content based on pattern matching, wherein determining whether the webpage includes malicious content comprises,
extracting a first code pattern from the webpage, wherein the first code pattern comprises one or more codes corresponding to structural elements of the webpage;
successively performing a lookup in each index of a plurality of malware code patterns based on a different code selected from the first code pattern until a successful lookup or all indexes of the plurality of malware code patterns has been accessed, wherein looking up the first code pattern in each index comprises,
determining positional indexing of the index, wherein the positional indexing is different for each index and indicates an alignment and a position relative to the alignment;
selecting the code in the first code pattern according to the positional indexing of the index;
looking up the selected code in the index;
based on a successful lookup, determining that the webpage includes malicious content; and
based on a determination that the webpage includes malicious content, indicating the one of the plurality of malware code patterns returned from the successful lookup.

2. The method of claim 1, wherein an alignment indicated by positional indexing for an index comprises one of left, right, and middle with respect to a set of codes in a code pattern.

3. The method of claim 2, wherein selecting the code in the first code pattern according to the positional indexing of the index comprises:
determining which code in the first code pattern corresponds to the alignment indicated by the positional indexing of the index; and
selecting the code at the position indicated by the positional indexing of the index relative to the determined alignment code.

4. The method of claim 3, wherein selecting the code in the first code pattern according to the positional indexing of the index comprises:
determining that the alignment for the index is middle,
wherein determining which code in the first code pattern corresponds to the alignment comprises determining which code in the first code pattern corresponds to the middle of the first code pattern, and
wherein selecting the code at the position indicated by the positional indexing comprises selecting the code at the position relative to the determined middle code of the first code pattern.

5. The method of claim 1, wherein looking up the first code pattern in the index based on the selected code comprises searching the index for the selected code and, if found, determining whether the first code pattern matches the one of the malware code patterns indexed by the index matching the selected code.

6. The method of claim 1, wherein a code of a code pattern corresponds to one of a JavaScript section of a webpage, a form section of a webpage, a title section of a webpage, a cascading style sheet section of a webpage, an iframe section of a webpage, a header section of a hypertext transfer protocol (HTTP) request or response, and an image section of a webpage.

7. The method of claim 1 wherein looking up the selected code in the index comprises hashing the selected code and determining whether the hash of the selected code occurs in the index.

8. The method of claim 1 further comprising searching a second plurality of malware code patterns for a match with the first code pattern based on failure of the successive lookups, wherein the second plurality of malware code patterns is not covered by the indexes of the plurality of malware code patterns.

9. A non-transitory, machine-readable medium having program code stored thereon, the program code comprising instructions to:
build a lookup structure for pattern matching-based malicious webpage detection, wherein the instructions to build the lookup structure comprise instructions to:
analyze a plurality of malware code patterns to determine which one or more positional indexing covers the most or all of the malware code patterns with minimal indexes;
for each positional indexing determined from the analysis, build an index for the plurality of malware code patterns according to the positional indexing, wherein the instructions to build an index according to each positional indexing determined from the analysis comprise instructions to,
for each of the plurality of malware code patterns covered by the positional indexing, select the code in the malware code pattern at a position relative to an alignment indicated by the positional indexing and set a key for the malware code pattern based on the selected code; and
based on building multiple indexes for the plurality of malware code patterns, prioritize lookup order of the multiple indexes from most coverage to least coverage.

10. The non-transitory, machine-readable medium of claim 9, wherein the instructions to analyze a plurality of malware code patterns to determine which one or more positional indexing covers the most or all of the malware code patterns with minimal indexes comprise instructions to:
for each malware code pattern, generate representations of the malware code pattern in terms of position with respect to each alignment including left, right, and middle; and
determine the one or more positional indexing that covers the most or all of the plurality of malware code patterns with minimal indexes as a covering set problem using the representations of the plurality of malware code patterns.

11. The non-transitory, machine-readable medium of claim 10, wherein the instructions to generate representations of each malware code pattern in terms of position with respect to each alignment comprise the instructions to acknowledge a position occupied by an unstructured code but not indicating the unstructured code in the representation.

12. The non-transitory, machine-readable medium of claim 9, wherein the program code further comprises instructions to store an indication of the positional indexing for each index.

13. The non-transitory, machine-readable medium of claim 9, wherein each malware code pattern comprises one or more codes, each code corresponding to a different section of a webpage.

14. An apparatus comprising:
a processor; and
a machine-readable medium having stored thereon instructions executable by the processor to cause the apparatus to,
determine whether a webpage includes malicious content based on pattern matching, wherein the instructions to determine whether the webpage includes malicious content comprise instructions executable by the processor to cause the apparatus to,
extract a first code pattern from the webpage, wherein the first code pattern comprises one or more codes corresponding to structural elements of the webpage;
successively perform a lookup in each index of a plurality of malware code patterns based on a different code selected from the first code pattern until a successful lookup or all indexes of the plurality of malware code patterns has been accessed, wherein the instructions to successively perform the lookup comprise instructions executable by the processor to cause the apparatus to,
determine positional indexing of the index, wherein the positional indexing is different for each index and indicates an alignment and a position relative to the alignment;
select the code in the first code pattern according to the positional indexing of the index;
look up the selected code in the index;
based on a successful lookup, determine that the webpage includes malicious content; and
based on a determination that the webpage includes malicious content, indicate the one of the plurality of malware code patterns returned from the successful lookup.

15. The apparatus of claim 14, wherein an alignment indicated by positional indexing for an index comprises one of left, right, and middle with respect to a set of codes in a code pattern.

16. The apparatus of claim 15, wherein the instructions to select the code in the first code pattern according to the positional indexing of the index comprise instructions executable by the processor to cause the apparatus to:
determine which code in the first code pattern corresponds to the alignment indicated by the positional indexing of the index; and
select the code at the position indicated by the positional indexing of the index relative to the determined alignment code.

17. The apparatus of claim 16, wherein the instructions to select the code in the first code pattern according to the positional indexing of the index comprise instructions executable by the processor to cause the apparatus to:
determine that the alignment for the index is middle,
wherein the instructions to determine which code in the first code pattern corresponds to the alignment comprise instructions to determine which code in the first code pattern corresponds to the middle of the first code pattern, and
wherein the instructions to select the code at the position indicated by the positional indexing comprise instructions to select the code at the position relative to the determined middle code of the first code pattern.

18. The apparatus of claim 14, wherein the instructions to look up the selected code in the index comprise the instructions executable by the processor to cause the apparatus to search the index for the selected code and, if found, determine whether the first code pattern matches the one of the malware code patterns indexed by the index matching the selected code.

19. The apparatus of claim 14, wherein a code of a code pattern corresponds to one of a JavaScript section of a webpage, a form section of a webpage, a title section of a webpage, a cascading style sheet section of a webpage, an iframe section of a webpage, a header section of a hypertext transfer protocol (HTTP) request or response, and an image section of a webpage.

20. The apparatus of claim 14 wherein the instructions to look up the selected code in the index comprise instructions executable by the processor to cause the apparatus to hash the selected code and determine whether the hash of the selected code occurs in the index.
